(19) United States
(12) Patent Application Publication
(10) Pub. No.: US 2020/0226310 A1
(43) Pub. Date: Jul. 16, 2020

(54) Systems and Methods for Computational Windowing

(71) Applicant: OnScale, Inc., Redwood City, CA (US)

(72) Inventors: John Mould, Mountain View, CA (US); Dave Vaughan, Mountain View, CA (US); Scott McClennan, Sunnyvale, CA (US); Laura Carcione, Los Altos, CA (US); Gerald Harvey, San Francisco, CA (US); Ryan Diestelhorst, Atlanta, GA (US)

(21) Appl. No.: 16/740,960

(22) Filed: Jan. 13, 2020

Related U.S. Application Data
(60) Provisional application No. 62/791,073, filed on Jan. 11, 2019.

(51) Int. Cl. G06F 30/23; G06F 17/13; G06F 30/27

(52) U.S. Cl. CPC G06F 30/23; G06F 2111/08; G06F 30/27; G06F 17/13

(57) ABSTRACT

Described here is a method for the discretization of a complex model using computational windows to define the physics, solve type (explicit/implicit), mesh (type/density), and time step used within distinct spatial domains for finite element analysis. The windows can be defined manually or automatically and can be leveraged to reduce the overall computational energy and time required to solve the model.

### CROSS-REFERENCE TO RELATED APPLICATIONS

This application claims the benefit of U.S. provisional patent application No. 62/791,073, filed on Jan. 11, 2019, and entitled “SYSTEMS AND METHODS FOR COMPUTATIONAL WINDOWING,” the disclosure of which is expressly incorporated herein by reference in its entirety.

### TECHNICAL FIELD

The present disclosure relates to computational windowing techniques for finite element mechanical, thermomechanical, electromechanical, and/or magnetomechanical analysis.

### BACKGROUND

The finite element analysis of a given problem grows in complexity as the number of distinct physics being calculated in the model increases. These physics may include, but are not limited to, acoustic and elastic wave propagation, structural dynamics, electrostatics, electromagnetics, fluid dynamics, ray tracing, and steady-state and transient thermal. Each of these physics can be described mathematically using partial differential equations (PDEs) of space and time variables subject to a necessary set of initial and boundary conditions. However, the mathematical nature of each can vary dramatically, requiring different computational strategies to solve efficiently.

For example, transient wave propagation is governed by a hyperbolic PDE that is best solved in the time domain using an explicit integration scheme, while equilibrium or diffusion problems are governed by elliptic or parabolic PDEs that are better solved using an implicit integration scheme. In many cases, the solution to a given problem is dependent on the evolving interaction between two or more physics, i.e. a “multi-physics problem”. In transient multi-physics problems, it is sometimes possible to describe the combined physics using a single integrated set of equations, however, due to different mathematical natures and time scales involved, it is often more efficient to couple solvers designed for each physics at discrete time intervals. In this approach, the coupled solution evolves by using the solution of one computation as a source term or boundary condition for another.

In a fluid-structure interaction (FSI) problem, the structural dynamics solution computes the position of the structure at each time interval, which becomes a boundary condition for the flow equations. The pressure state computed by the fluid solution is applied as forces on the structure. Similarly, in an electro-mechanical problem, equations describe the evolution of electric charge due to mechanical deformation, which is applied as a source term in an electrostatic solve for electric potential. The stresses due to electric field are then applied as a forcing function for the mechanical solve. As the coupling interval (time step) is reduced, the coupled solution converges.

This type of coupling is very common in computational physics software, however, the time required to solve problems of the nature described can be prohibitive if all of the coupling physics must be calculated at every element and time step. Computational windowing, as described herein, can reduce this time substantially.

### SUMMARY

The present disclosure pertains to a method for improving the efficiency of multi-physics simulation by creating computational windows that individually modify the parameters or scope of the simulation in the area or volume defined. These windows make it simple to discretize a domain into areas with specific multi-physics, solve type (explicit vs. implicit), time step, or mesh. The windows may be created by the user, or automatically based on specific attributes of the model such as mesh density, materials, and desired run time. Large efficiencies can be gained in many applications by limiting coupling between unique physics to windows smaller than the full domain.

An example computer-implemented method for discretizing a physical model is described herein. The method includes receiving a simulation model, partitioning a spatial domain of the simulation model into a plurality of physics windows, assigning a first physics window of the simulation model for solving a first type of physics, and assigning a second physics window of the simulation model for solving a second type of physics. The first type of physics is represented by a first set of element equations, and the second type of physics is represented by a second set of element equations, where the first and second types of physics are different. The method also includes creating a matrix including the first and second sets of element equations, and solving the first and second types of physics using the matrix.

Additionally, each of the first and second types of physics is one of mechanical, thermomechanical, electromechanical, magnetomechanical, or combination thereof. Alternatively or additionally, the first and second sets of element equations are partial differential equations (PDEs). Alternatively or additionally, the simulation model is a two-dimensional (2D) or three-dimensional (3D) model.

In some implementations, the step of solving the first and second types of physics using the matrix includes simultaneously solving the first and second sets of element equations. Alternatively or additionally, the step of solving the first and second types of physics using the matrix includes solving the first and second types of physics without iteratively solving the first and second sets of element equations.

In some implementations, the first and second physics windows are at different spatial locations of the simulation model.

In some implementations, the first and second types of physics assigned to the first and second physics windows of the simulation model, respectively, are selected by a user. Alternatively, the first and second types of physics are assigned to the first and second physics windows of the simulation model, respectively, using a deterministic algorithm based on a property of the simulation model. Alternatively, the first and second types of physics are assigned to the first and second physics windows of the simulation model, respectively, using a probabilistic machine learning algorithm.

In some implementations, the method optionally includes partitioning the spatial domain of the simulation model into a plurality of mesh windows, each respective mesh window defining a size and/or type of finite mesh elements used within it.

In some implementations, the method optionally includes partitioning the spatial domain of the simulation model into a plurality of solve windows, each respective solve window defining an approach for solving element equations within it.

In some implementations, the method optionally includes partitioning the spatial domain of the simulation model into a plurality of timing windows, each respective timing window defining a size of a time step used within it.

Another computer-implemented method for discretizing a physical model is described herein. The method includes receiving a simulation model, partitioning a spatial domain of the simulation model into a plurality of solve windows, assigning a first solve window of the simulation model for solving a first set of element equations using an implicit method, and assigning a second solve window of the simulation model for solving a second set of element equations using an explicit method. The method also includes creating a matrix including the first and second sets of element equations, and solving the first and second sets of element equations using the matrix.

Additionally, the first and second sets of element equations are partial differential equations (PDEs). Alternatively or additionally, the simulation model is a two-dimensional (2D) or three-dimensional (3D) model.

In some implementations, the step of solving the first and second sets of element equations using the matrix includes simultaneously solving the first and second sets of element equations. Alternatively or additionally, the step of s solving the first and second sets of element equations using the matrix includes solving the first and second types of physics without iteratively solving the first and second sets of element equations.

In some implementations, the first and second solve windows are at different spatial locations of the simulation model.

In some implementations, the implicit and explicit methods assigned to the first and second solve windows of the simulation model, respectively, are selected by a user. Alternatively, the implicit and explicit methods are assigned to the first and second solve windows of the simulation model, respectively, using a deterministic algorithm based on a property of the simulation model. Alternatively, the implicit and explicit methods are assigned to the first and second solve windows of the simulation model, respectively, using a probabilistic machine learning algorithm.

Yet another computer-implemented method for discretizing a physical model is described herein. The method includes receiving a simulation model, partitioning a spatial domain of the simulation model into a plurality of timing windows, assigning a first timing window of the simulation model for solving a first set of element equations using a first time step, and assigning a second timing window of the simulation model for solving a second set of element equations using a second time step. The first and second time steps are different. The method also includes creating a matrix including the first and second sets of element equations, and solving the first and second types of physics using the matrix.

Additionally, the first and second sets of element equations are partial differential equations (PDEs). Alternatively or additionally, the simulation model is a two-dimensional (2D) or three-dimensional (3D) model.

In some implementations, the step of solving the first and second sets of element equations using the matrix includes simultaneously solving the first and second sets of element equations. Alternatively or additionally, the step of s solving the first and second sets of element equations using the matrix includes solving the first and second types of physics without iteratively solving the first and second sets of element equations.

In some implementations, the first and second timing windows are at different spatial locations of the simulation model.

In some implementations, the first and second time steps assigned to the first and second timing windows of the simulation model, respectively, are selected by a user. Alternatively, the first and second time steps are assigned to the first and second timing windows of the simulation model, respectively, using a deterministic algorithm based on a property of the simulation model. Alternatively, the first and second time steps are assigned to the first and second timing windows of the simulation model, respectively, using a probabilistic machine learning algorithm.

Yet another computer-implemented method for discretizing a simulation model is described herein. The method includes partitioning a spatial domain of the simulation model into a plurality of physics windows, each respective physics window defining a type of physics solved within it; partitioning the spatial domain of the simulation model into a plurality of mesh windows, each respective mesh window defining a size and/or type of finite mesh elements used within it; partitioning the spatial domain of the simulation model into a plurality of solve windows, each respective solve window defining an approach for solving partial differential equations within it; and partitioning the spatial domain of the simulation model into a plurality of timing windows, each respective timing window defining a size of a time step used within it.

In some implementations, the type of physics solved within a respective physics window is mechanical, thermomechanical, electromechanical, magnetomechanical, or combination thereof.

In some implementations, the size and/or type of finite mesh elements used within a respective mesh window is a structured grid or an unstructured mesh.

In some implementations, the approach for solving partial differential equations within a respective solve window is an explicit analysis, an implicit analysis, a small deformation analysis, a large deformation analysis, a time domain analysis, a frequency domain analysis, or combination thereof.

In some implementations, at least one of the physics, mesh, solve, or timing windows is defined by a user. Alternatively or additionally, at least one of the physics, mesh, solve, or timing windows is defined using a deterministic algorithm based on a property of the simulation model. The property of the simulation model is a material, a boundary condition, a simulation time, a load, or combination thereof. Alternatively or additionally, at least one of the physics, mesh, solve, or timing windows is defined using a probabilistic machine learning algorithm.

In some implementations, at least one of the physics, mesh, solve, or timing windows changes in shape, size, and number over time.

Yet another computer-implemented method for discretizing a model is described herein. The method includes creating a plurality of computational windows for discretizing the model, where each respective computational window defines a parameter or scope of the simulation within it. The computational windows include a physics window, a mesh window, a solve window, a timing window, or combination thereof.

An example system for discretizing a physical model is also described herein. The system can include a processor and a memory operably connected to the processor, where the memory has computer-executable instructions stored thereon. The computer-executable instructions cause the processor to receive a simulation model, partition a spatial domain of the simulation model into a plurality of physics windows, assign a first physics window of the simulation model for solving a first type of physics, and assign a second physics window of the simulation model for solving a second type of physics. The first type of physics is represented by a first set of element equations, and the second type of physics is represented by a second set of element equations, where the first and second types of physics are different. The computer-executable instructions also cause the processor to create a matrix including the first and second sets of element equations, and solve the first and second types of physics using the matrix.

Another example system for discretizing a physical model is described herein. The system can include a processor and a memory operably connected to the processor, where the memory has computer-executable instructions stored thereon. The computer-executable instructions cause the processor to receive a simulation model, partition a spatial domain of the simulation model into a plurality of solve windows, assign a first solve window of the simulation model for solving a first set of element equations using an implicit method, and assign a second solve window of the simulation model for solving a second set of element equations using an explicit method. The computer-executable instructions cause the processor to create a matrix including the first and second sets of element equations, and solve the first and second sets of element equations using the matrix.

Yet another example system for discretizing a physical model is described herein. The system can include a processor and a memory operably connected to the processor, where the memory has computer-executable instructions stored thereon. The computer-executable instructions cause the processor to receive a simulation model, partition a spatial domain of the simulation model into a plurality of timing windows, assign a first timing window of the simulation model for solving a first set of element equations using a first time step, and assign a second timing window of the simulation model for solving a second set of element equations using a second time step. The first and second time steps are different. The computer-executable instructions also cause the processor to create a matrix including the first and second sets of element equations, and solve the first and second types of physics using the matrix.

Yet another example system for discretizing a physical model is described herein. The system can include a processor and a memory operably connected to the processor, where the memory has computer-executable instructions stored thereon. The computer-executable instructions cause the processor to partition a spatial domain of the simulation model into a plurality of physics windows, each respective physics window defining a type of physics solved within it; partition the spatial domain of the simulation model into a plurality of mesh windows, each respective mesh window defining a size and/or type of finite mesh elements used within it; partition the spatial domain of the simulation model into a plurality of solve windows, each respective solve window defining an approach for solving partial differential equations within it; and partition the spatial domain of the simulation model into a plurality of timing windows, each respective timing window defining a size of a time step used within it.

Yet another example system for discretizing a physical model is described herein. The system can include a processor and a memory operably connected to the processor, where the memory has computer-executable instructions stored thereon. The computer-executable instructions cause the processor to create a plurality of computational windows for discretizing the model, where each respective computational window defines a parameter or scope of the simulation within it. The computational windows include a physics window, a mesh window, a solve window, a timing window, or combination thereof.

It should be understood that the above-described subject matter may also be implemented as a computer-controlled apparatus, a computer process, a computing system, or an article of manufacture, such as a computer-readable storage medium. Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE FIGURES

The components in the drawings are not necessarily to scale relative to each other. Like reference numerals designate corresponding parts throughout the several views. These and other features of will become more apparent in the detailed description in which reference is made to the appended drawings wherein:

FIG. 1 illustrates a two-dimensional (2D) electromechanical model partitioned into mechanical and electromechanical windows.

FIG. 2 illustrates the 2D electromechanical model with a meshing window around the electromechanical boundary.

FIG. 3 illustrates the 2D electromechanical model partitioned into explicit and implicit mechanical windows.

FIG. 4 illustrates the 2D electromechanical model partitioned into a plurality of timing windows.

FIG. 5 illustrates a 2D model partitioned into a plurality of solve windows.

FIG. 6 illustrates a 2D model partitioned into a plurality of timing windows.

FIG. 7 is an example computing device.

### DETAILED DESCRIPTION

The present disclosure can be understood more readily by reference to the following detailed description, examples, drawings, and their previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching. To this end, those skilled in the relevant art will recognize and appreciate that many changes can be made, while still obtaining beneficial results. It will also be apparent that some of the desired benefits can be obtained by selecting some of the features without utilizing other features. Accordingly, those who work in the art will recognize that many modifications and adaptations may be possible and can even be desirable in certain circumstances, and are contemplated by this disclosure. Thus, the following description is provided as illustrative of the principles and not in limitation thereof.

As used throughout, the singular forms “a,” “an” and “the” include plural referents unless the context clearly dictates otherwise. Thus, for example, reference to “a model” can include two or more such models unless the context indicates otherwise.

The term “comprising” and variations thereof as used herein is used synonymously with the term “including” and variations thereof and are open, non-limiting terms.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The present disclosure relates to a method for the discretization of simulation models for finite element analysis (FEA). Such discretization can occur in multiple facets of a simulation model by creating windows that govern what physics are solved (elastodynamic, piezoelectric, electrostatic, electromagnetic, fluid dynamic, ray tracing, thermal, etc.), how they are solved (explicitly vs. implicitly), where they are solved (mesh element type and density), and/or when they are solved (time step). Optimization of these parameters in the spatial domain can produce dramatic reductions in the computational energy required to produce a solution, with the potential for improvement growing as a function of the complexity of the model, particularly when multiple kinds of physics are considered.

Moreover, the process of optimization can take multiple forms. In one implementation, the user can manually define windows in the spatial domain and assign each of the relevant simulation parameters (physics, solve type, mesh type/density, time step) within those windows. Another implementation can rely on algorithms to define windows and determine what simulation parameters are appropriate to optimize for computational energy. These algorithms may be deterministic—such that the model will be predictably partitioned and assigned parameters based on pre-defined functions of the materials, boundary conditions, simulation time, and loads, or probabilistic—such that the model is partitioned and assigned simulation parameters based on the solver's previously learned associations from a set of similar simulation models. The latter approach is a practical application of machine learning.

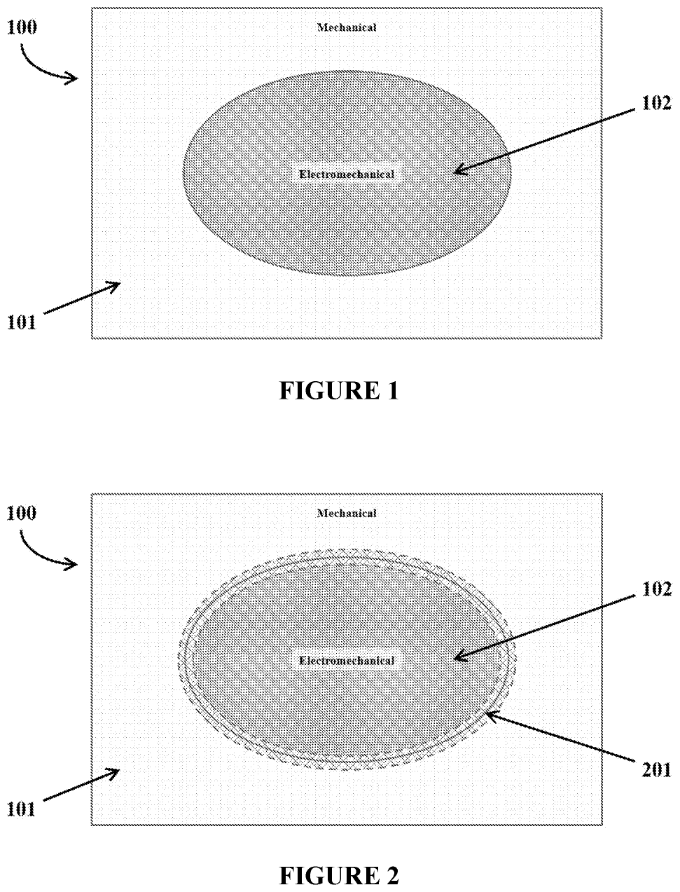

Given that the physics govern the optimization of many other aspects of the simulation, it is contemplated that a model should first be partitioned based on the applicable physics. For example, in a piezoelectric transducer, there is typically an active piezoelectric layer connected to electrodes where a coupled circuit solve is required. The transducer is surrounded by a larger region that can be approximated as electrically-inactive, including a substrate and packaging where only a mechanical solve is necessary. The electric solve only includes the degrees-of-freedom in the electromechanical window. FIG. 1 shows a simple representation of a simulation model 100 partitioned into two computational windows—a mechanical window 101 and an electromechanical window 102. In FIG. 1, the simulation model 100 is a two-dimensional (2D) model. A 2D model is provided only as an example. The techniques described herein can be implemented using a three-dimensional (3D) model. Additionally, the simulation model 100 can be a model of the piezoelectric transducer discussed above, which is provided only as an example. It should be understood that various mechanical, thermomechanical, electromechanical, and/or magnetomechanical systems can be represented by simulation models. The electromechanical window 102 models the region where electric solve is needed (e.g., the active piezoelectric layer connected to electrodes), while the mechanical window 101 models the region where mechanical solve is needed (e.g., the larger, electrically-inactive portion of the transducer). Thus, in FIG. 1, the mechanical window 101 and the electromechanical window 102 are at different spatial locations of the simulation model 100.

The mechanical window 101 and the electromechanical window 102 can be modeled by respective sets of element equations such as partial differential equations (PDEs), for example. It should be understood that PDEs are provided only as an example. This disclosure contemplates modeling the windows with other types of element equations. The mechanical window 101 and the electromechanical window 102 of FIG. 1 are used to model different types of physics. In FIG. 1, the first type of physics (i.e., mechanical) is represented by a first set of element equations, and the second type of physics (i.e., electromechanical) is represented by a second set of element equations. Although mechanical and electromechanical windows are provided as examples, this disclosure contemplates modeling different types of physics, which can includes but are not limited to mechanical, thermomechanical, electromechanical, and/or magnetomechanical physics. Additionally, the number of physics windows (i.e., two) in FIG. 1 are provided only as an example. It should be understood that the simulation model 100 can include more than two physics windows, e.g., three, four, five, etc. physics windows, where at least two of the physics windows are used to solve different types of physics.

The respective sets of element equations used to solve the mechanical and electromechanical physics of mechanical window 101 and electromechanical window 102 can be combined into a matrix, e.g., a single solution matrix. Accordingly, the mechanical and electromechanical physics (i.e., different types of physics, which are represented by different sets of element equations) can be solved using the same solution matrix. The first and second sets of element equations of the solution matrix can therefore be solved simultaneously. In other words, the techniques described herein do not require iteratively solving the element equations representing the mechanical physics (i.e., first set of element equations) and the element equations representing the electromechanical physics (e.g., second set of element equations), where the solution to one set of element equations serves as a boundary condition for the other set of element equations. The ability to window a plurality of different physics in the same simulation model 100 is important because it allows all of the relevant physics to be solved efficiently in the same solution matrix. This is in contrast to conventional techniques, which iterate between separate sets of equations until a solution is achieved. Optionally, in this example, computational energy in the electromechanical window 102 can be further optimized by performing the solve for electrode charge independently of the solve for electric potential to reduce a single, large, non-symmetric matrix solve to two smaller matrix solves—one symmetric positive definite and the other non-symmetric.

As described herein, this disclosure contemplates that the type of physics assigned to the different windows (e.g., mechanical window 101 and electromechanical window 102) can be selected by the user in some implementations. Alternatively, the type of physics assigned to the different windows can be assigned using a deterministic algorithm based on a property of the simulation model. Properties of the model can include a material, a boundary condition, a simulation time, a load, or combination thereof. Alternatively, the type of physics assigned to the different windows can be assigned using a probabilistic machine learning algorithm.

In another example, a model in which thermal physics is included may not require a thermal solution across the entire model. Specific areas where there is plastic deformation or friction might require a thermal window due to the expectation of a large thermal gradient, whereas large portions of the model could be excluded to improve efficiency. Any number of thermal windows may be created in this manner where thermal physics are expected to play a significant role. While mechanical, electrical, and thermal physics are presented here as examples, it is contemplated that any combination of physics may be partitioned in this manner.

Optionally, the method further includes partitioning the spatial domain of the simulation model 100 into a plurality of mesh windows, each respective mesh window defining a size and/or type of finite mesh elements used within it. For example, in addition to defining what physics (e.g., mechanical and electromechanical in FIG. 1) are solved in the computational windows, it is contemplated that the discretization of the spatial domain into finite elements can also benefit from windowing in this manner. One way to divide the spatial domain is to create a structured grid of voxels that provide an ordered and memory efficient method of discretizing the surfaces/volumes in the model. It should be understood that structured grids are limited in how precisely they can represent complex geometries, e.g. curves. In FIG. 1, the electromechanical window 102 has a curved boundary that can be more accurately represented using a conformal mesh of triangles (or polyhedrons in a 3D example). It is contemplated that a conformal mesh window 201 can be created to define the region around this boundary as shown in FIG. 2, and that within this computational window 201, a conformal mesh is used to discretize the surfaces/volumes in the region. This is in contrast to the rest of the model, where a structured grid mesh window is maintained for computational efficiency. This is referred to as hybrid meshing. Hybrid meshing is described in detail in U.S. Ser. No. 16/536,463, filed Aug. 9, 2019, and titled “Hybrid Meshing Method for Finite Element Analysis.” This disclosure contemplates that any region of the model can be windowed in this manner, either manually or automatically, based on the complexity of the surface/volume boundaries in the region. It should be understood that physics windows (e.g., mechanical window 101 and electromechanical window 102) and mesh windows (e.g., conformal mesh window 201) can be at the same and/or different locations of the simulation model 100.

Optionally, the method further includes partitioning the spatial domain of the simulation model 100 into a plurality of solve windows, each respective solve window defining an approach for solving element equations within it. For example, while the physics (FIG. 1) and finite element discretization (FIGS. 1 and 2) have now been defined as described above, it is possible to determine how the resulting element equations are constructed and solved. As described herein, the sets of element equations can be PDEs. PDEs within a respective solve window can be solved with an explicit analysis, an implicit analysis, a small deformation analysis, a large deformation analysis, or combination thereof. In an explicit solution approach, the PDEs are discretized into algebraic equations such that the unknown variables are functions only of previous time step values. This decouples the equations from the surrounding grid with the constraint that the time step be smaller than the time required for information to travel between grid points. In an implicit solution, unknown variables are functions of current time step values as well as previous timestep values, which requires simultaneous solution of the entire system of linear equations, i.e. construction and inversion of a global matrix. This is a computationally expensive step if done repeatedly during a time domain simulation but has no stability constraints on time step.

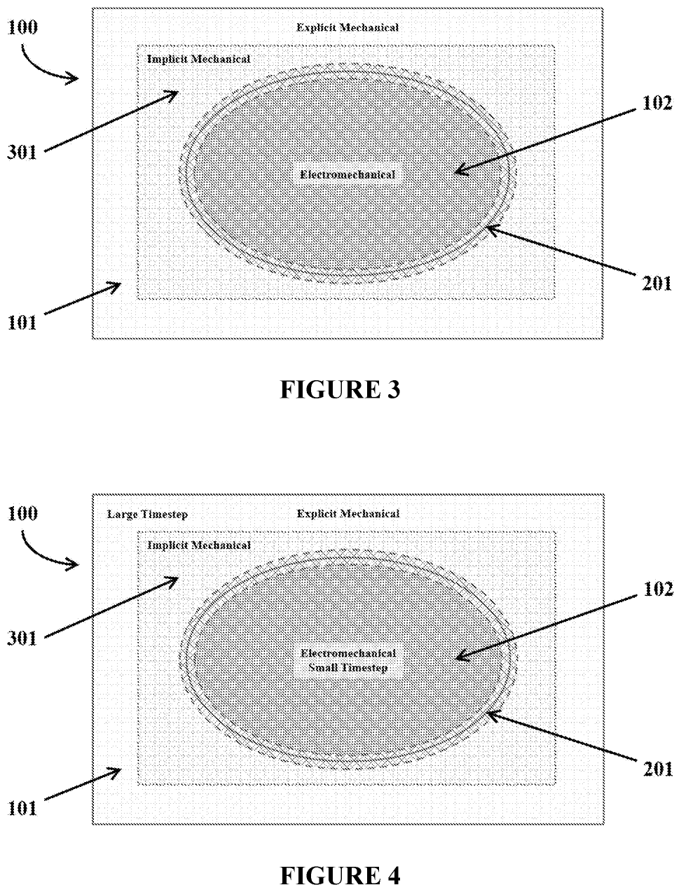

Using the previous example, an explicit solution may be most efficient for the majority of the design, except in regions where geometry features are small relative to the wavelength of interest. A person skilled in the art would understand that each wavelength must be resolved with at least two sampling points to avoid aliasing (e.g., according to Nyquist theory). As a result, at least two (and typically more, e.g., three, four, five, . . . ten, etc.) elements per wavelength are used to obtain accurate results. This creates difficulties for an explicit solution when a feature is relatively small relative to the wavelength of interest. Thus, in such regions, elements must be made small compared to the majority of the finite element grid, which requires a proportionally smaller timestep for a stable solution and consequently a longer solution time. An approach commonly employed by explicit solvers to handle locally small elements in structural dynamics simulations is to artificially increase the density of these elements, which increases the stable time step. However, this alters the wave speed in the elements, which is unacceptable in a wave propagation analysis. In this window, an implicit mechanical solution is determined to be more efficient. Referring now to FIG. 3, the mechanical window 101 is subdivided by adding an implicit mechanical solve subwindow 301. In this region, the same physics (e.g., mechanical) are considered, however the mechanical solution is performed implicitly to improve computational efficiency. Outside of the implicit mechanical solve subwindow 301, the mechanical solution is performed explicitly. The explicit mechanical solve subwindow is labeled “Explicit Mechanical” in FIG. 3. It should be understood that physics windows (e.g., mechanical window 101 and electromechanical window 102) and solve windows (e.g., implicit and explicit solve windows) can be at the same and/or different locations of the simulation model 100.

Using this approach, the solution at the boundaries between the implicit mechanical solve subwindow 301 and explicit mechanical solve window (labeled “Explicit Mechanical” in FIG. 3) must be considered carefully to maintain accuracy. Grid elements are contained fully by a single solve window (e.g., implicit solve window or explicit solve window), but node points connecting elements can lie on the boundary between two or more solve windows (e.g., boundary between implicit and explicit solve windows). In the case where one window is implicit, and the other window is explicit, the nodes are considered to be part of the implicit window. In a finite element solution, the governing equations are discretized at the nodes as integrals of the surrounding element variables. The window boundary nodes therefore include contributions (mass, strain, etc.) from elements in the explicit solution window, but form part of the implicit solution. Updated nodal quantities such as velocity form boundary constraints for the explicit window solution.

A further spatial breakdown of the solution domain can optionally be done to separate regions where a large-deformation analysis is required from regions where a small-deformation assumption is sufficient. A person skilled in the art would understand how to separate such regions for deformation analysis. For example, if the strain and rotation at a given point are guaranteed to remain small relative to the grid element dimension at that location, an assumption can be made that the reference configuration of the material remains unchanged throughout the simulation. This simplifying assumption can greatly reduce the amount of computation required as the element strain-displacement relations in an explicit solution and the global stiffness matrix in an implicit solution need only be computed once at that beginning of the simulation. In large-deformation analyses, these matrices must be recomputed at each timestep. Separating the domain into small-deformation and large-deformation regions can therefore greatly improve efficiency.

Optionally, the method further includes partitioning the spatial domain of the simulation model 100 into a plurality of timing windows, each respective timing window defining a size of a time step used within it. For many combinations of physics, it is desirable to have control over the timing of each solution step. For example, in the electromechanical model described, one may be most interested in acquiring a result with high timing resolution in only the region within some distance of the electromechanical window 102. The outer region of the mechanical window 101 may have characteristics that make it less interesting at small time scales, such as, for example, a large damping coefficient. Referring now to FIG. 4, this characteristic of the simulation model 100 can be used to reduce the computational energy required by creating a timing window (labeled “Large Timestep” in FIG. 4), outside which the PDEs for the mechanical physics are solved at larger time steps than they are in the electromechanical portion of the simulation model 100. It should be understood that physics windows (e.g., mechanical window 101 and electromechanical window 102) and timing windows (e.g., large and small time step windows) can be at the same and/or different locations of the simulation model 100.

It is lastly contemplated that the computational widows discussed here need not be permanent in time. As the simulation of a model (e.g., simulation model 101) progresses in time (for time-domain analyses), the effects of a particular kind of physics may change, and accordingly the window defining where that kind of physics is solved may change in shape, increase in size, decrease in size, or disappear entirely. Similarly, the windows defining the type of solve (large vs. small deformation), mesh type (structured grid vs. unstructured mesh), or time resolution may change in shape, increase in size, decrease in size, or disappear entirely. How the windows change in time may be defined in a rigid manner by the user if certain time-domain properties of the model are well-understood, such as the presence of an electric pulse that exists only at the beginning of the simulation, or defined fluidly by algorithms that deterministically or probabilistically decide when they can be modified to improve computational efficiency. Accordingly, the size and/or shape of a computation window (e.g., mechanical window 101, electromechanical window 102, conformal mesh window 201, implicit mechanical solve window 301, or time step window) can dynamically over the course of the simulation. The change can be user initiated by a user or automatically by an algorithm.

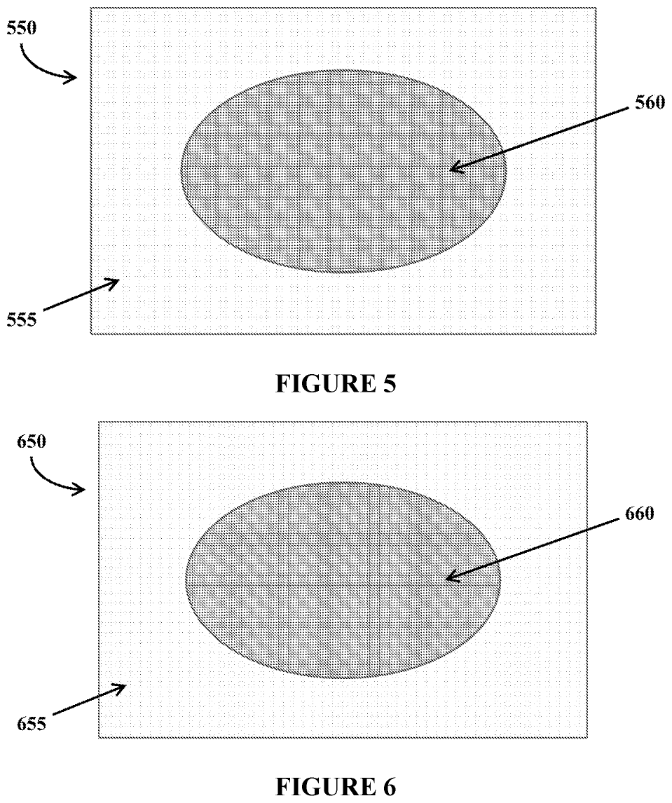

Referring now to FIG. 5, a 2D model partitioned into a plurality of solve windows is shown. In the example described above with regard to FIGS. 1-5, the electromechanical model is partitioned into a plurality of physics windows. Alternatively, in some implementations, a simulation model 550 can be partitioned into a plurality of solve windows 555 and 560. As described above, some physics are more efficiently solved using explicit approach, while other physics are more efficiently solved using implicit approach. Combining these two approaches into the same simulation model 550 allows for greater flexibility and efficiency in combining physics. In FIG. 5, the simulation model 550 is a 2D model. A 2D model is provided only as an example. The techniques described herein can be implemented using a 3D model. Additionally, the simulation model 550 can be a model of a piezoelectric transducer, which is provided only as an example. It should be understood that various mechanical, thermomechanical, electromechanical, and/or magnetomechanical systems can be represented by simulation models. The number of solve windows (i.e., two) in FIG. 5 are provided only as an example. It should be understood that the simulation model 550 can include more than two solve windows, e.g., three, four, five, etc. solve windows.

As shown in FIG. 5, a spatial domain of the simulation model 550 is partitioned into a plurality of solve windows. Thereafter, a first solve window 555 is assigned for solving a first set of element equations using an implicit method, and a second solve window 560 is assigned for solving a second set of element equations using an explicit method. As described herein, a single solution matrix including the first and second sets of element equations is created, and the first and second sets of element equations are solved using the solution matrix. Optionally, this disclosure contemplates further partitioning the simulation model 550 into one or more physics, mesh, and/or timing windows.

Referring now to FIG. 6, a 2D model partitioned into a plurality of timing windows is shown. In some implementations, a simulation model 650 can be partitioned into a plurality of timing windows 655 and 660, where the time steps are different in each window. According to conventional FEA techniques, the simulation is performed with a single time step used throughout a model. In FIG. 6, the simulation is performed with a plurality of time steps. As described herein, the ability to increase the resolution in time in areas where rapid changes are occurring is valuable in providing both accuracy in those regions and efficiency in regions where physical changes are occurring more slowly. In FIG. 6, the simulation model 650 is a 2D model. A 2D model is provided only as an example. The techniques described herein can be implemented using a 3D model. Additionally, the simulation model 650 can be a model of a piezoelectric transducer, which is provided only as an example. It should be understood that various mechanical, thermomechanical, electromechanical, and/or magnetomechanical systems can be represented by simulation models. The number of timing windows (i.e., two) in FIG. 6 are provided only as an example. It should be understood that the simulation model 650 can include more than two timing windows, e.g., three, four, five, etc. timing windows.

As shown in FIG. 6, a spatial domain of the simulation model 650 is partitioned into a plurality of solve windows. Thereafter, a first timing window 655 is assigned for solving a first set of element equations using a first time step, and a second timing window 660 is assigned for solving a second set of element equations using a second time step. The first and second time steps are different (e.g., one time step is larger than the other). As described herein, a single solution matrix including the first and second sets of element equations is created, and the first and second sets of element equations are solved using the solution matrix. Optionally, this disclosure contemplates further partitioning the simulation model 650 into one or more physics, mesh, and/or solve windows.

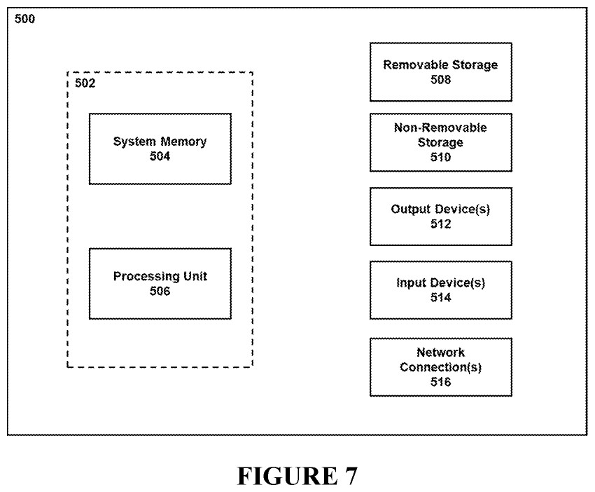

Referring to FIG. 7, an example computing device 500 upon which the methods described herein may be implemented is illustrated. It should be understood that the example computing device 500 is only one example of a suitable computing environment upon which the methods described herein may be implemented. Optionally, the computing device 500 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 500 typically includes at least one processing unit 506 and system memory 504. Depending on the exact configuration and type of computing device, system memory 504 may be volatile (such as random access memory (RAM)), non-volatile (such as read-only memory (ROM), flash memory, etc.), or some combination of the two. This most basic configuration is illustrated in FIG. 7 by dashed line 502. The processing unit 506 may be a standard programmable processor that performs arithmetic and logic operations necessary for operation of the computing device 500. The computing device 500 may also include a bus or other communication mechanism for communicating information among various components of the computing device 500.

Computing device 500 may have additional features/functionality. For example, computing device 500 may include additional storage such as removable storage 508 and non-removable storage 510 including, but not limited to, magnetic or optical disks or tapes. Computing device 500 may also contain network connection(s) 516 that allow the device to communicate with other devices. Computing device 500 may also have input device(s) 514 such as a keyboard, mouse, touch screen, etc. Output device(s) 512 such as a display, speakers, printer, etc. may also be included. The additional devices may be connected to the bus in order to facilitate communication of data among the components of the computing device 500. All these devices are well known in the art and need not be discussed at length here.

The processing unit 506 may be configured to execute program code encoded in tangible, computer-readable media. Tangible, computer-readable media refers to any media that is capable of providing data that causes the computing device 500 (i.e., a machine) to operate in a particular fashion. Various computer-readable media may be utilized to provide instructions to the processing unit 506 for execution. Example tangible, computer-readable media may include, but is not limited to, volatile media, non-volatile media, removable media and non-removable media implemented in any method or technology for storage of information such as computer readable instructions, data structures, program modules or other data. System memory 504, removable storage 508, and non-removable storage 510 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 506 may execute program code stored in the system memory 504. For example, the bus may carry data to the system memory 504, from which the processing unit 506 receives and executes instructions. The data received by the system memory 504 may optionally be stored on the removable storage 508 or the non-removable storage 510 before or after execution by the processing unit 506.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method for discretizing a physical model, comprising:
receiving a simulation model;
partitioning a spatial domain of the simulation model into a plurality of physics windows;
assigning a first physics window of the simulation model for solving a first type of physics, the first type of physics being represented by a first set of element equations;
assigning a second physics window of the simulation model for solving a second type of physics, the second type of physics being represented by a second set of element equations;
creating a matrix comprising the first and second sets of element equations; and
solving the first and second types of physics using the matrix, wherein the first and second types of physics are different.

2. The computer-implemented method of claim 1, wherein the step of solving the first and second types of physics using the matrix comprises simultaneously solving the first and second sets of element equations.

3. The computer-implemented method of claim 1, wherein the step of solving the first and second types of physics using the matrix comprises solving the first and second types of physics without iteratively solving the first and second sets of element equations.

4. The computer-implemented method of claim 1, wherein each of the first and second types of physics is one of mechanical, thermomechanical, electromechanical, magnetomechanical, or combination thereof.

5. The computer-implemented method of any one of claim 1, wherein the first and second physics windows are at different spatial locations of the simulation model.

6. The computer-implemented method of claim 1, wherein the first and second types of physics assigned to the first and second physics windows of the simulation model, respectively, are selected by a user.

7. The computer-implemented method of claim 1, wherein the first and second types of physics are assigned to the first and second physics windows of the simulation model, respectively, using a deterministic algorithm based on a property of the simulation model.

8. The computer-implemented method of claim 1, wherein the first and second types of physics are assigned to the first and second physics windows of the simulation model, respectively, using a probabilistic machine learning algorithm.

9. The computer-implemented method of claim 1, further comprising partitioning the spatial domain of the simulation model into a plurality of mesh windows, each respective mesh window defining a size and/or type of finite mesh elements used within it.

10. The computer-implemented method of claim 1, further comprising partitioning the spatial domain of the simulation model into a plurality of solve windows, each respective solve window defining an approach for solving element equations within it.

11. The computer-implemented method of claim 1, further comprising partitioning the spatial domain of the simulation model into a plurality of timing windows, each respective timing window defining a size of a time step used within it.

12. The computer-implemented method of claim 1, wherein the first and second sets of element equations are partial differential equations (PDEs).

13. The computer-implemented method of claim 1, wherein the simulation model is a two-dimensional (2D) or three-dimensional (3D) model.

14. A system for discretizing a physical model, comprising:
a processor; and
a memory operably connected to the processor, wherein the memory has computer-executable instructions stored thereon that, when executed by the processor, cause the processor to:
receive a simulation model;
partition a spatial domain of the simulation model into a plurality of physics windows;
assign a first physics window of the simulation model for solving a first type of physics, the first type of physics being represented by a first set of element equations;
assign a second physics window of the simulation model for solving a second type of physics, the second type of physics being represented by a second set of element equations;
create a matrix comprising the first and second sets of element equations; and
solve the first and second types of physics using the matrix, wherein the first and second types of physics are different.

15. A computer-implemented method for discretizing a physical model, comprising:
receiving a simulation model;
partitioning a spatial domain of the simulation model into a plurality of solve windows;
assigning a first solve window of the simulation model for solving a first set of element equations using an implicit method;
assigning a second solve window of the simulation model for solving a second set of element equations using an explicit method;
creating a matrix comprising the first and second sets of element equations; and
solving the first and second sets of element equations using the matrix.

16. (canceled)

17. (canceled)

18. The computer-implemented method of claim 15, wherein the first and second solve windows are at different spatial locations of the simulation model.

19. (canceled)

20. (canceled)

21. (canceled)

22. The computer-implemented method of claim 15, wherein the first and second sets of element equations are partial differential equations (PDEs).

23. (canceled)

24. (canceled)

25. A computer-implemented method for discretizing a physical model, comprising:
receiving a simulation model;
partitioning a spatial domain of the simulation model into a plurality of timing windows;
assigning a first timing window of the simulation model for solving a first set of element equations using a first time step;
assigning a second timing window of the simulation model for solving a second set of element equations using a second time step;
creating a matrix comprising the first and second sets of element equations; and
solving the first and second sets of element equations using the matrix, wherein the first and second time steps are different.

26. (canceled)

27. (canceled)

28. The computer-implemented method of claim 25, wherein the first and second timing windows are at different spatial locations of the simulation model.

29. (canceled)

30. (canceled)

31. (canceled)

32. The computer-implemented method of claim 25, wherein the first and second sets of element equations are partial differential equations (PDEs).

33-45. (canceled)
